(19) United States
(12) Patent Application Publication
(10) Pub. No.: US 2012/0291258 A1
(43) Pub. Date: Nov. 22, 2012

(54) Process for Producing Nested Refuse Bags

(76) Inventor: Johnny Dominick, Mobile, AL (US)

(21) Appl. No.: 13/111,556

(22) Filed: May 19, 2011

(51) Int. Cl. B23P 11/00

(52) U.S. Cl. 29/428

(57) ABSTRACT

A process for preparing a package of nested refuse bags includes the steps of (a) providing a continuous roll of connected bags, each bag having opposed open and closed ends when separated from the continuous roll of bags; (b) separating a first bag from the continuous roll of bags; (c) separating a next bag from the continuous roll; (d) opening the next bag's open end to present an opening larger than the closed end of an immediately proceeding bag; (e) moving the next bag open end over the immediately previously separated bag closed end until the next bag open end is substantially adjacent the immediately previously separated bag open end and the immediately previously separated bag is substantially nested in the next bag; and (f) returning to the step of separating a next bag until a predetermined number of bags have been separated from the continuous roll of bags.

### BACKGROUND OF THE INVENTION

This invention relates generally to refuse collecting bags and, more particularly, to a process that, when carried out, produces a plurality of nested refuse collection bags.

Plastic bags are commonly used in residential and commercial trash receptacles. In the home context, the trash receptacle positioned in a kitchen always seems to fill up the fastest and must be changed the most frequently. Changing the trash bag is an undesirable task and one that can be inconvenient and frustrating. Specifically, the filled bag must be pulled upwardly from the container, the supply of new bags must be located (such as a roll or box of trash bags), and the new bag must be inserted into the receptacle. Often just locating the supply of bags when in a hurry is the most frustrating aspect of the change routine.

In the past, consumers have attempted to simplify this process by storing extra bags under the sink, beside the trash receptacle, or even in the bottom of the receptacle so that they can be found when needed. Although assumably effective for their intended purposes, the prior methods may still be inconvenient in that the bag changing procedure is still required every single time a trash bag become full.

Therefore, it would be desirable to have a process to produce a refuse bag pack having multiple nested trash bags that may be inserted into a trash receptacle and that eliminates the need to insert a new trash bag each time a full bag is removed.

### SUMMARY OF THE INVENTION

A process for preparing a package of nested refuse bags according to the present invention includes the steps of (a) providing a continuous roll of connected bag, each bag having opposed open and closed ends when separated from the continuous roll of bags; (b) separating a first bag from the continuous roll of bags; (c) separating a next bag from the continuous roll; (d) opening the next bag's open end to present an opening larger than the closed end of an immediately proceeding bag; (e) moving the next bag open end over the immediately previously separated bag closed end until the next bag open end is substantially adjacent the immediately previously separated bag open end and the immediately previously separated bag is substantially nested in the next bag; and (f) returning to the step of separating a next bag until a predetermined number of bags have been separated from the continuous roll of bags.

Therefore, a general object of this invention is to provide a process that produces a collection of refuse collection bags that are nested relative to one another such that removal of one bag, such as to gather up collected trash, leaves the remaining bags in the refuse containment member, i.e. trash can.

Another object of this invention is to provide a process having steps that produce a predetermined number of nested refuse collecting bags that may be situated in a trash can for use in collecting trash.

Still another object of this invention is to provide a process, as aforesaid, that produces a collection of nested refuse bags in which the outermost bag includes an adhesive tab that may be used to temporarily anchor the collection of nested refuse bags in the trash can.

Yet another object of this invention is to provide a process, as aforesaid, in which each refuse bag includes a drawstring for closing a bag open end upon removal from the collection of refuse bags.

A further object of this invention is to provide a process, as aforesaid, that produces a collection of nested bags in a cost-effective manner.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a collection of nested refuse bags prepared by a process according to a preferred embodiment of the present invention;

FIG. 2 is another perspective view as in FIG. 1 with the bags partially exploded from the nested configuration;

FIG. 3a is another perspective view of the collection of nested bags as in FIG. 1; and

FIG. 3b is an isolated view on an enlarged scale taken from a portion of FIG. 3a.

### DESCRIPTION OF THE PREFERRED EMBODIMENT

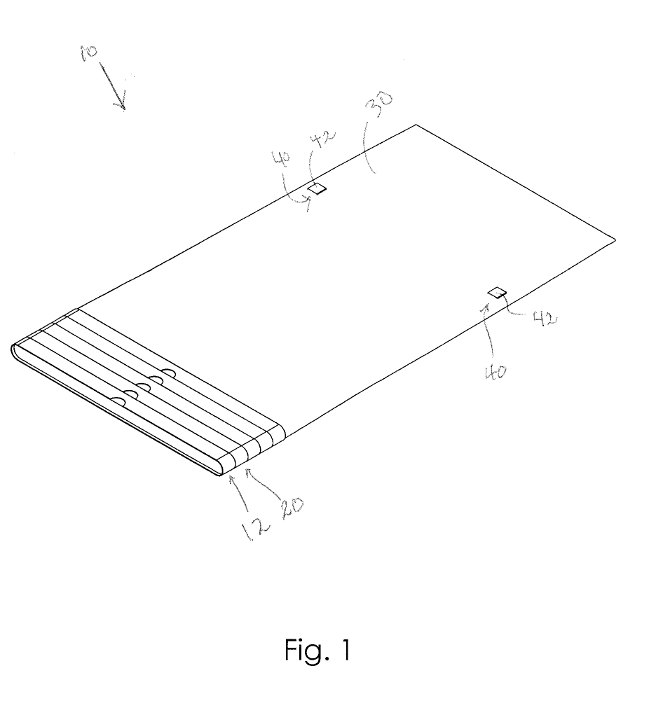

A process that produces a collection of nested refuse bags according to a preferred embodiment of the present invention will now be described in detail with reference to FIGS. 1 to 3b of the accompanying drawings.

The process for manufacturing a continuous roll of plastic bags is known and includes melting plastic resin pellets and blowing the melted pellets into a tube resulting in a continuous sheet having one or more layers. Traditionally, the continuous sheet is cut into individual bags using heated bars that seal one end (i.e. the bottom edge) and one end remaining unsealed/open. It is understood that the process of producing a continuous roll of refuse collecting bags may include equipment such as conveyor belts, idler rolls, extrusion equipment, and the like.

It is understood that a machine or other mechanical equipment (not shown) may be used to carry out the inventive process described herein. Persons of ordinary skill in the art would be capable of building a machine to carry out the process according to the description disclosed herein.

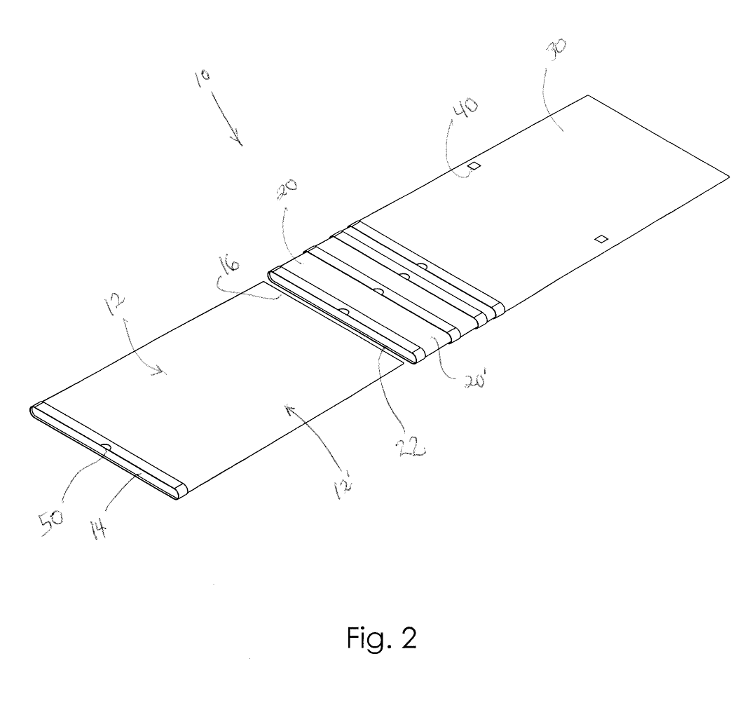

The process that produces a collection of nested refuse bags 10 includes providing a continuous roll of connected refuse bags (not shown), such as in the traditional manner described above. Individual bags may then be separated from the continuous roll and manipulated according to the present inventive process. More particularly, a first bag 12 may be separated from the continuous roll of refuse bags and includes opposed open 14 and closed 16 ends (FIG. 2). The first bag 12 may be separated from the continuous roll of bags by heated bars, a blade, or the like. The first bag 12 may be held in position by a framework having mechanical arms. Specifically, arm members may move the first bag 12 forward of the continuous roll of bags. The first bag 12 will then be considered in the process to be “an immediately previously separated bag” 12′ in that it was separated before a next bag 20. In the figures the same first bag will be labeled both 12 and 12′ for the reason just described—that it takes on two functional roles depending on the stage of the process. This terminology will be better understood below as next bags may be repeatedly separated and nested with previously separated bags.

Then, a next bag 20 may be separated from the continuous roll of bags in substantially the same manner as the first bag 12. The next bag 20 includes next bag open 22 and closed ends. According to the process, the next bag open end 22 is opened wider than a width of the previously separated bag's closed end 14. To be clear, the open end may be opened in all directions so as to present an opening sufficient to surround and receive the closed end of the previously separated bag. According to the inventive process, the next bag 20 is moved forward in the direction of the previously separated bag. More particularly, the open end 22 of the next bag 20 is moved, such as in a pulling action, over and around the closed end 14 of the previously separated bag 12′ until the open end 22 of the next bag 20 is substantially adjacent the open end 12 of the previously separated bag 12′. The result is that the previously separated bag 12′ is nested inside the next bag 20. The “next bag” 20 will then be considered in the process as being the so-called “immediately previously separated bag” 20′ as it relates to the next bag separated for the nesting process as described below. Note that the next bag will be labeled in the figures with reference numerals 20 and 20′ to reflect the change in terminology depending on the stage of the process.

The process then returns to the step of separating another “next” bag from the continuous roll of bags, opening its open end enough that it can be moved up and around the previous bag or a plurality of nested bags as the case may be. It is understood that this repeat of successively separating and nesting of bags will continue until a predetermined number of bags has been separated and nested together. Upon reaching the end of a nesting cycle, the nested bags (FIG. 1) may be removed from the machinery or simply moved along to a packaging process such as, for example, folding the bags, rolling the bags, or insertion into a box. The packaging of refuse bags is generally known in the art.

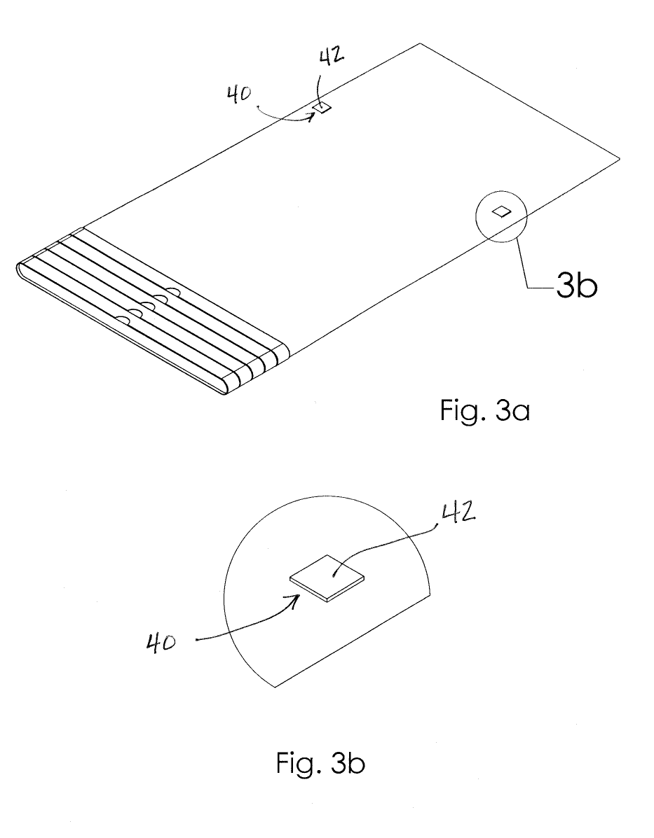

The process may also include additional steps that produce a slightly different product than described previously. For instance, the process may include adhering at least one adhesive tab 40 or other similar fastener to an outer surface of the last bag 30 in the group of nested bags as best shown in FIGS. 3a and 3b. It is understood that multiple adhesive tabs 40 may be spaced apart on the outer surface of the last bag 30. Preferably, the adhesive tab 40 or tabs are positioned somewhere on the lower half of the bag. The adhesive tab 40 may have an inner surface fixedly mounted to the last bag and an outer surface 42 having an adhesive capable of adhering the last bag 30 to an inner surface of a trash receptacle into which the group of nested bags may be inserted. Securing the group of nested bags is important so that the bags do not have a tendency to move upward or out of the receptacle when a single one of the nested bags is pulled upward from the rest and removed.

The process may also include insertion of a drawstring 50 into the upper edge of each bag adjacent the respective bag's open end. This process, however, may be a step in the process of producing the continuous roll of bags and is known in the art.

It is understood that while the process described herein has been to nest bags taken from a continuous roll of bags, it is also contemplated that bags that have already been formed may be picked up from a stack or even manually loaded into appropriate machinery and then nested according to the invention described herein. Accordingly, the process of providing a continuous roll of bags may alternatively be the step of providing a plurality of bags from a stack or other grouping of already-formed bags.

In use, a collection of nested refuse bags is produced according to the process described above. Specifically, a succession of bags is separated from a continuous roll of bags. Each separated bag is held until the next bag is also separated, the next bag's open end is further opened, the next bag is then moved or pulled forward so as to envelop the previously separated bag. In this way, the previously separated bag has become nested inside the next bag. This process is then repeated successively until a predetermined number of bags have been separated from the continuous roll of bags and nested together.

A collection of nested trash bags is useful to a consumer in that the collection may be inserted into a trash receptacle. When the innermost trash bag becomes full, it may be removed and disposed of and a next bag is already in position with no further action of insertion by the consumer. In this way, a consumer is likely not to need to insert a new collection of refuse bags for several days or, for some consumers, for several weeks.

It is understood that while certain forms of this invention have been illustrated and described, it is not limited thereto except insofar as such limitations are included in the following claims and allowable functional equivalents thereof.

1. A process for preparing a collection of nested refuse bags comprising the steps of:
(a) providing a continuous roll of connected bags;
(b) separating a first bag from said continuous roll of connected bags, said first bag having opposed first bag open and closed ends when separated from said continuous roll of connected bags;
(c) considering said first bag to be an immediately previously separated bag;
(d) separating a next bag from said continuous roll of connected bags, said next bag having opposed next bag open and closed ends when separated from said continuous roll of connected bags;
(e) opening said next bag open end enough to present an opening large enough to envelop and receive said immediately previously separated bag closed end;
(f) moving said next bag open end over said immediately previously separated bag closed end until said next bag open end is substantially adjacent said immediately previously separated bag open end and said immediately previously separated bag is substantially nested in said next bag;
(g) considering said next bag to be said immediately previously separated bag; and
(h) returning to step (d) until a predetermined number of next bags have been separated from said continuous roll of connected bags.

2. The process of claim 1, further comprising the step of adhering an adhesive tab to an outer surface a last next bag.

3. The process of claim 3, further comprising the step of inserting a drawstring into said open end of each said next bag.

4. A package of nested refuse bags manufactured according to the process of claim 3.

5. A package of nested refuse bags manufactured according to the process of claim 2.

6. The process of claim 1, wherein said step of opening said next bag open end includes providing mechanical means for holding said next bag open during said step of moving said next bag open end over said immediately previously separated bag closed end until said next bag open end is substantially adjacent said immediately previously separated bag open end.

7. The process of claim 1, wherein said step of moving said next bag open end over said immediately previously separated bag closed end includes providing mechanical means to move said next bag open end over said immediately previously separated bag closed end.
